(19) United States
(12) Patent Application Publication
(10) Pub. No.: US 2010/0299084 A1
(43) Pub. Date: Nov. 25, 2010

(54) TORQUE DETECTION DEVICE FOR TOOL

(75) Inventor: CHIANG KAO CHEN, TAIPEI HSIEN (TW)

Correspondence Address: ROSENBERG, KLEIN & LEE, 3458 ELLICOTT CENTER DRIVE-SUITE 101, ELLICOTT CITY, MD, 21043, US

(73) Assignee: LEGEND LIFESTYLE PRODUCTS CORP., TAIPEI (TW)

(21) Appl. No.: 12/780,316

(22) Filed: May 14, 2010

(30) Foreign Application Priority Data
May 20, 2009 (TW) 098208752

(51) Int. Cl. G01L 3/00

(52) U.S. Cl. 702/41

(57) ABSTRACT

A torque detection and display device is provided for a tool, including at least one connection body, at least one tool coupling bar, at least one torque detector, and a torque displaying/processing unit. The connection body has an end connected to the tool coupling bar and the tool coupling bar is connectable to at least one type of tool bit, such as screwdriver, a wrench socket, and a spanner. The connection body is enclosed by at least a tool housing. The torque detector is mounted to the connection body to detect a torque value of the rotation operation of the tool bit in either the clockwise direction or the counterclockwise direction through strain/deformation or semiconductor detection, and generates a torque detection signal. The torque displaying/processing unit is connected to the torque detector to receive the torque detection signal from the torque detector and display an actual torque value occurring in the rotation operation of the tool bit. As such, a torque detection and display device that features connection with various tool bits and detection and display an actual torque value occurring in the operation of the tool bit is formed.

### BACKGROUND OF THE INVENTION

1. Field of the Invention

The present invention relates to a torque detection device for tools, and in particular to a device applicable to a hand tool and comprising a connection body that is selectively coupled to various tool bits for detecting and display, in a digital form, an actual torque occurring in clockwise and counterclockwise rotation operations of the hand tool.

2. The Related Arts

Hand tools, such as screwdrivers, wrench sockets and spanners, are of wide applications in mechanical assembling and maintenance for fastening and/or loosening fasteners, such as bolts or screws, on mechanical parts. In certain applications of high precision mechanics, tightening/loosening of a threaded fastener often needs to follow a strict process and requirement for applying a proper magnitude of torque. An incorrect operation may lead to breaking or damage of the threading of the fastener and even damage to the operation function and precision of the machine itself. The conventionally used hand tools are not provided with a function of detecting and displaying torque during the operation of application of torque, and a user has to operate the hand tool based on his or her experience. This certainly leads to human error of improper operation. Further, externally mounting a torque detection device to an individual hand tool may lead to high costs of design and manufacturing of the hand tool in order to accommodate the mounting of the torque detection device. Further, this may not be feasible for all potential applications.

Related arts, such as Taiwan Patent Nos. 1300027 and 1307305,disclose arrangement of a torque detection/display or alarm device to a torque wrench. The torque detection and display device cannot be readily mounted to the torque wrench and makes the manufacture of the torque wrench difficult. Further, the two patent documents provide techniques that are only limited to the detection and display of torque for torque wrench and not applicable to other hand tools.

### SUMMARY OF THE INVENTION

The known hand tools are not provided with a torque detection and display mechanism, whereby the known hand tools are disadvantageous in the problems of improper application of torque or inadvertently causing damage to the fasteners that are being tightened or loosened. Further, the conventional techniques allow only detection and display of torque for torque wrenches.

Thus, the present invention aims to provide a toque detection device for tools, which comprises at least one connection body, at least one tool coupling bar, at least one torque detector, and a torque displaying/processing unit, wherein the connection body has an end connected to the tool coupling bar and the tool coupling bar is connectable to at least one type of tool bit, such as screwdriver, a wrench socket, and a spanner. The connection body is enclosed by at least a tool housing. The torque detector is mounted to the connection body to detect a torque value of the rotation operation of the tool bit in either the clockwise direction or the counterclockwise direction through strain/deformation or semiconductor detection, and generates a torque detection signal. The torque displaying/processing unit is connected to the torque detector to receive the torque detection signal from the torque detector and display an actual torque value occurring in the rotation operation of the tool bit. As such, a torque detection and display device that features connection with various tool bits and detection and display an actual torque value occurring in the operation of the tool bit is formed.

The efficacy of the torque detection and display device in accordance with the present invention is applicable to various hand tools and comprises a modularized connection body, a tool coupling bar, a torque detector, and a torque displaying/processing unit for coupling with tool bits of various hand tools to provide the various hand tools with the function of detection and display of torques without causing increase of costs of manufacturing and assembling of hand tools, so that efficient and low-cost detection and displaying of torque can be realized for clockwise and/or counterclockwise rotation operation of various hand tools.

### BRIEF DESCRIPTION OF THE DRAWINGS

The present invention will be apparent to those skilled in the art by reading the following description of preferred embodiments thereof, with reference to the attached drawings, wherein:

FIG. 1 shows a torque detection and display device in accordance with a first embodiment of the present invention;

FIG. 2 is an exploded view of FIG. 1;

FIG. 3 is a cross-sectional view of FIG. 1;

FIG. 4 shows a torque detection and display in accordance with a second embodiment of the present invention;

FIG. 5 shows a torque detection and display in accordance with a third embodiment of the present invention;

FIG. 6 shows a preferred example of application of the torque detection and display device in accordance with the present invention;

FIG. 7 is an exploded view of FIG. 6;

FIG. 8 is a partial perspective view of FIG. 6, showing the structure between a direction-switching device and the connection body;

FIG. 9 is a cross-sectional view of FIG. 6; and

FIG. 10 is an exploded view of the direction-switching device of FIG. 7.

### DETAILED DESCRIPTION OF THE PREFERRED EMBODIMENTS

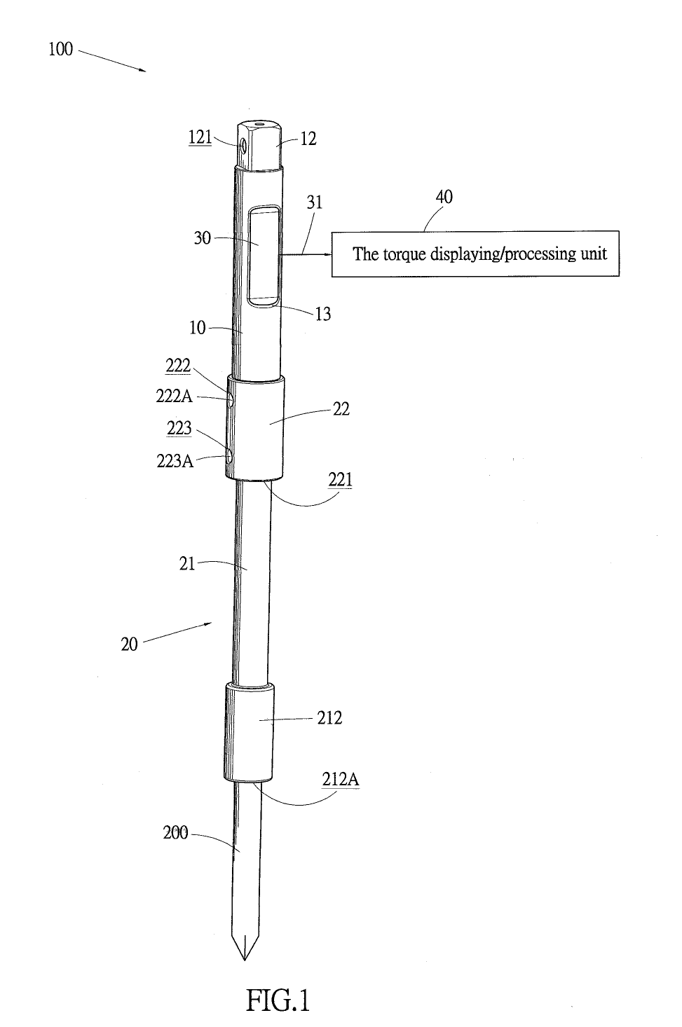

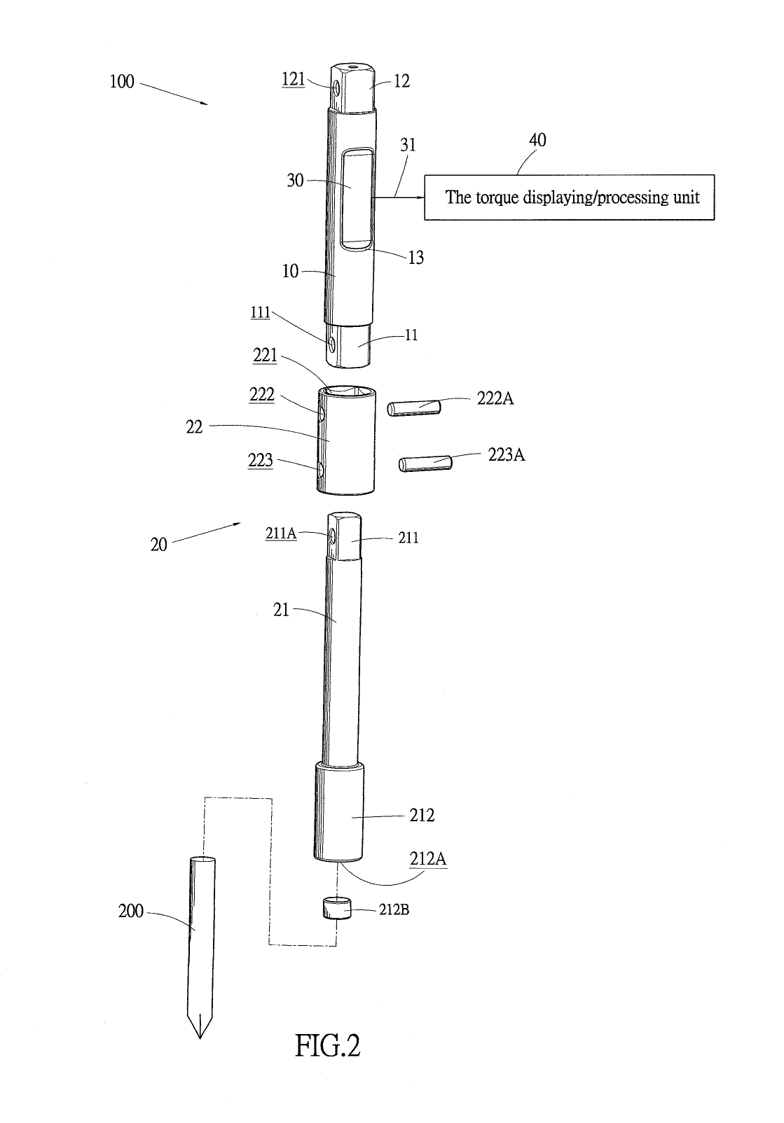

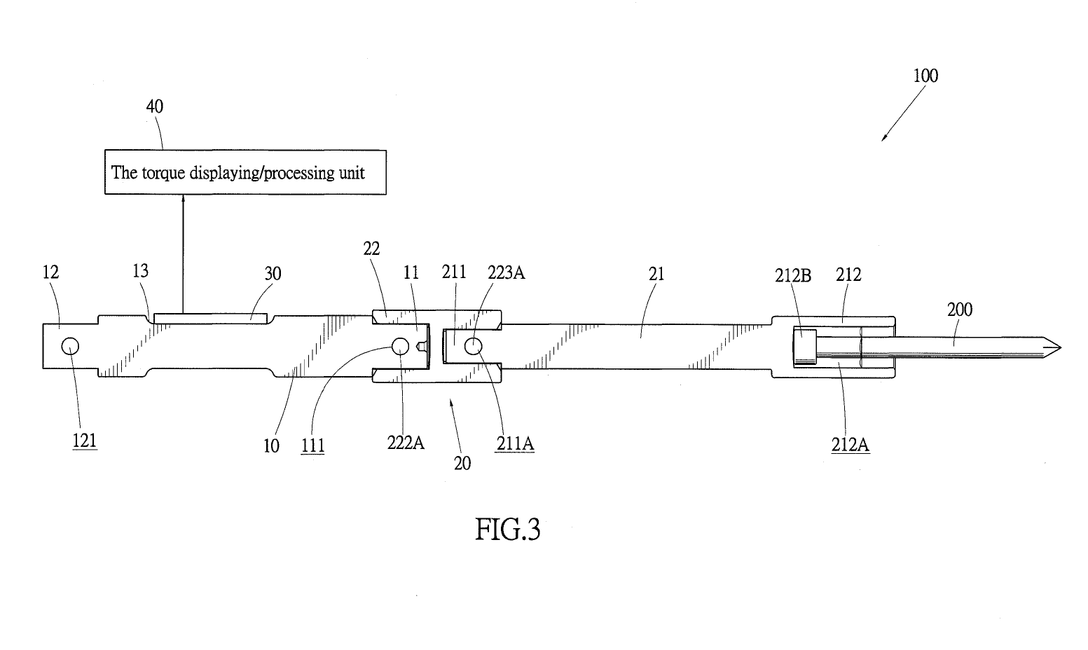

With reference to the drawings and in particular to FIGS. 1-3, a torque detection device constructed in accordance with a first embodiment of the present invention, generally designated at 100, is provided for a tool. The torque detection device 100 comprises at least one connection body 10 having opposite ends respectively forming connection ends 11, 12. The connection ends 11, 12 respectively form at least one connection hole 111, 121. The connection body 10 has an outer circumference forming a retention section 13.

At least one tool coupling bar 20 comprises an extender 21 and an adaptor 22. The extender 21 has opposite ends respectively forming a body connection section 211 and a tool connection section 212. The body connection section 211 forms at least one connection hole 211A and the tool connection section 212 has an end forming at least one connection bore 212A. The connection bore 212A receives therein at least one powerful magnet 212B, which provides a magnetic force to attract an end of at least one tool bit 200 that is inserted into the connection bore 212A for helping retaining the tool bit 200 within the connection bore 212A. The tool bit 200 is not limited to any specific type and in the instant embodiment, a screwdriver bit is taken as an example, but other rotation-operated tools, such as wrench sockets and spanners, can also be used and are considered within the scope of the present invention.

The adaptor 22 forms therein at least one connection hole 221 that has two ends respective for receiving the insertion of the connection end 11 of the connection body 10 and the body connection section 211 formed on an end of the extender 21. The adaptor 22 forms at each of opposite end sections thereof at least one retention hole 222, 223. The retention hole 222 corresponds to the connection hole 111 formed at one end of the connection body 10 so that a pin 222A is allowed to extend through the retention hole 222 and the connection hole 111 for connection, whereby the connection end 11 at one end of the connection body 10 .is connected to and fixed to the adaptor 22 of the tool coupling bar 20. Further, the connection hole 211A of the body connection section 211 formed on one end of the extender 21 corresponds to the retention hole 223 on one end of the adaptor 22 so that a pin 223A is allowed to extend through the retention hole 223 and the connection hole 211A for connection, whereby the body connection section 211 formed on one end of the extender 21 is connected to and fixed to the adaptor 22, and the connection body 10 and tool coupling bar 20 are coupled together.

The construction of the tool coupling bar 20 is not limited to being composed of the extender 21 and the adaptor 22. For example, the extender 21 and the adaptor 22 can be integrally formed as a unitary device or can be of other constructions offering an equivalent function, which are all considered within the scope of the present invention. Similarly, the connection between the connection body 10 and the tool coupling bar 20 is not limited to the connection realized through the adaptor 22 and the pin 222A as described above.

At least one torque detector 30 is mounted to the retention section 13 of the connection body 10 and the torque detector 30 comprises sensor elements that employ strain/deformation detection or semiconductor detection of torque values. In the instant embodiment, a strain/deformation resistor is taken as an example, but other devices, such as an integrated circuit device, that is capable of detecting torque can be used and are considered within the scope of the present invention. The torque detector 30 detects a torque induced by clockwise or counterclockwise rotation of the tool bit 200 that is coupled to the tool coupling bar 20 connected to the connection end 11 formed on one end of the connection body 10, and generates a torque detection signal 31 as an output.

At least one torque displaying/processing unit 40 comprises circuits for displaying torque value and displaying operation functions. The torque displaying/processing unit 40 is connected to the torque detector 30 to receive the torque detection signal 31 generated by the torque detector 30 for displaying an actual torque value of the rotation operation of the tool bit 200.

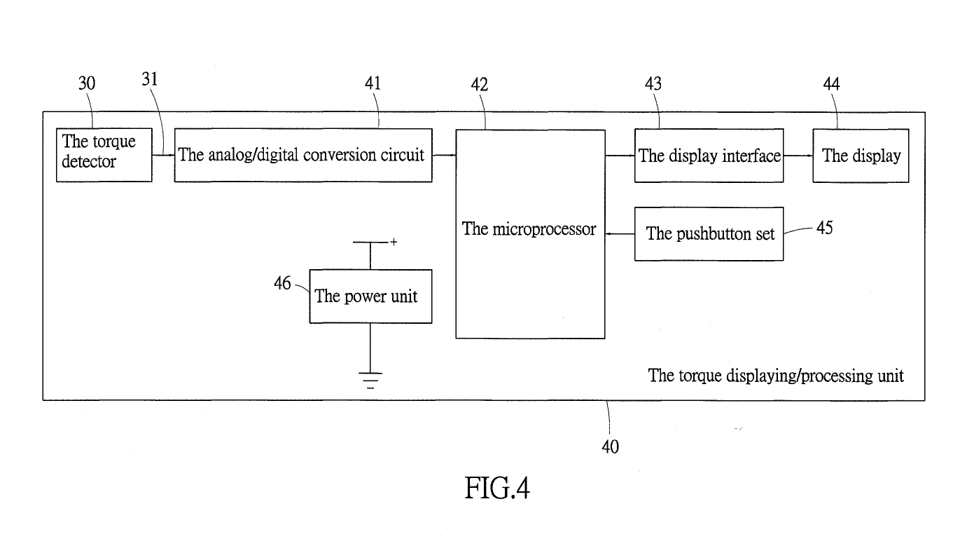

Referring also to FIG. 4, a second embodiment of the torque detection device 100 in accordance with the present invention is show, wherein the torque displaying/processing unit 40 comprises at least one analog/digital conversion circuit 41, a microprocessor 42, a display interface 43, a display 44, a pushbutton set 45, and a power unit 46. The analog/digital conversion circuit 41 is connected to the torque detector 30 to convert the torque detection signal 31 into a digital torque value. The microprocessor 42 is connected to the analog/digital conversion circuit 41 to receive the output of torque value from the analog/digital conversion circuit 41. The microprocessor 42 offers the functions of temporary data storage, display control, and manipulation. The display interface 43 is connected to the microprocessor 42 to convert the torque value into a torque displaying signal. The display 44 is connected to the display interface 43 to process and display the torque displaying signal from the display interface 43. The display 44 is not limited to any specific type and a liquid crystal display (LCD) is taken as an example in the instant embodiment. Other displays of equivalent functions, such as a light-emitting diode (LED) based display, are also considered within the scope of the present invention.

The pushbutton set 45 is connected to the microprocessor 42 to provide instructions for displaying operation to the microprocessor 42, such as a control instruction for switching units of torque to be displayed or to change displaying brightness.

The power unit 46 supplies working power to the analog/digital conversion circuit 41, the microprocessor 42, the display interface 43, the display 44, and the pushbutton set 45. The power unit 46 is not limited to any specific type and a direct-current (DC) power source is taken as an example in the instant embodiment. However, other power supply devices, such as a DC rectification device, can also be used and are considered within the scope of the present invention.

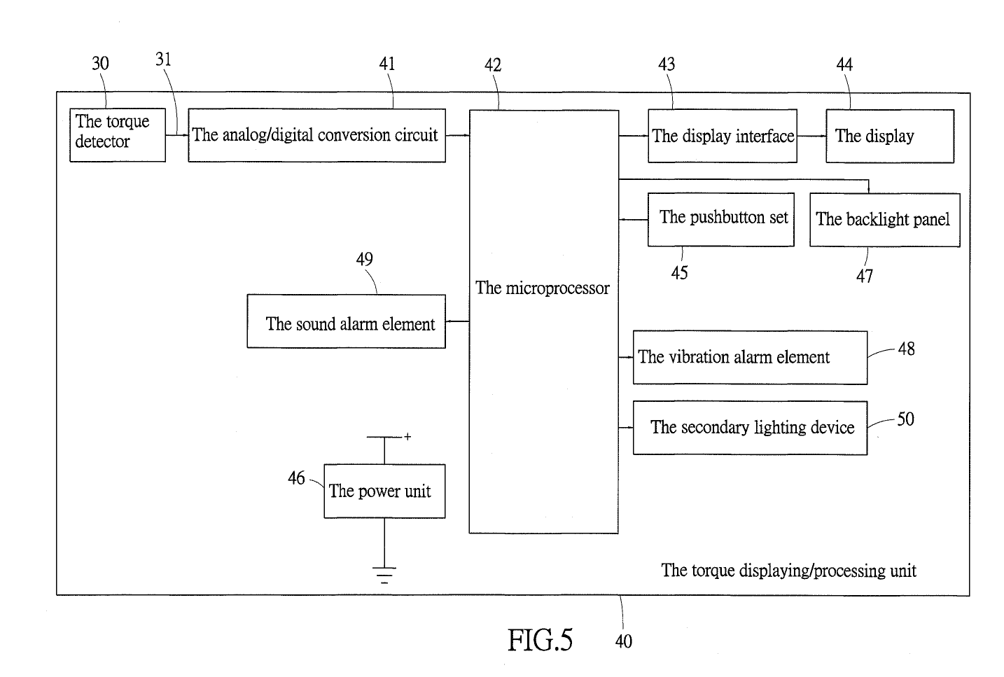

Referring also to FIG. 5, a third embodiment of the torque detection device 100 in accordance with the present invention is shown, wherein the torque displaying/processing unit 40 as discussed with reference to FIG. 4 is further composed of a backlight panel 47 and at least one vibration alarm element 48, a sound alarm element 49, and a secondary lighting device 50. The backlight panel 47 is connected to the microprocessor 42 to provide backlighting for displaying by the display 44 and the control of brightness is realized through the pushbutton set 45. The vibration alarm element 48 and the sound alarm element 49 are connected to the microprocessor 42, whereby the microprocessor 42, upon detecting a torque value exceeding a threshold, activates the vibration alarm element 48 and the sound alarm element 49 to generate a vibration force and a sound alarm, notifying a user of the torque value of the tool bit 200 that is being operated exceeding a threshold. The threshold is defined by user operating the pushbutton set 45 to be temporarily held in the microprocessor 42.

The vibration alarm element 48 and the sound alarm element 49 discussed above are not limited to any specific types and in the instant embodiment, a vibration motor is taken as an example of the vibration alarm element 48 and a buzzer is an example of the sound alarm element 49. Other electrical vibration elements and sound generation devices offering equivalent functions can be used and are considered within the scope of the present invention.

The secondary lighting device 50 is connected to the microprocessor 42 and the power unit 46. The secondary lighting device 50 is controlled by the microprocessor 42 to light on or off in accordance with control instructions of light on/off entered through the pushbutton set 45 to the microprocessor 42, whereby the secondary lighting device 50 may illuminate the rotation operation of the tool bit 200. The secondary lighting device 50 is not limited to any specific type and high-brightness LEDs are taken as an example in the instant embodiment.

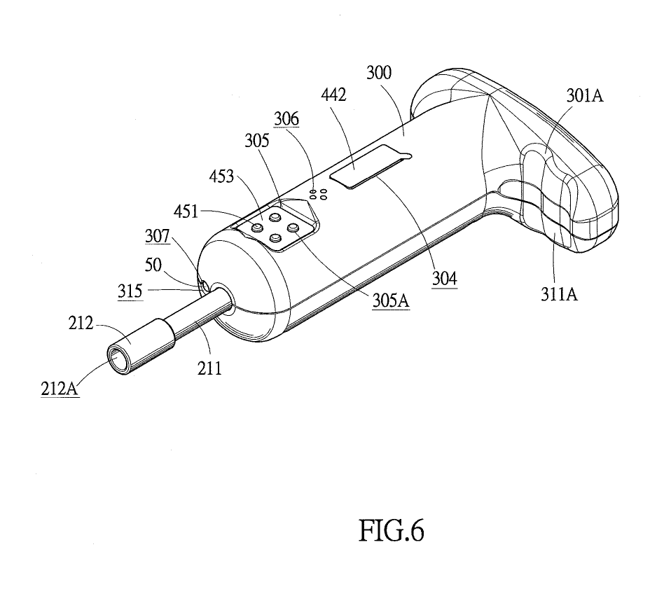

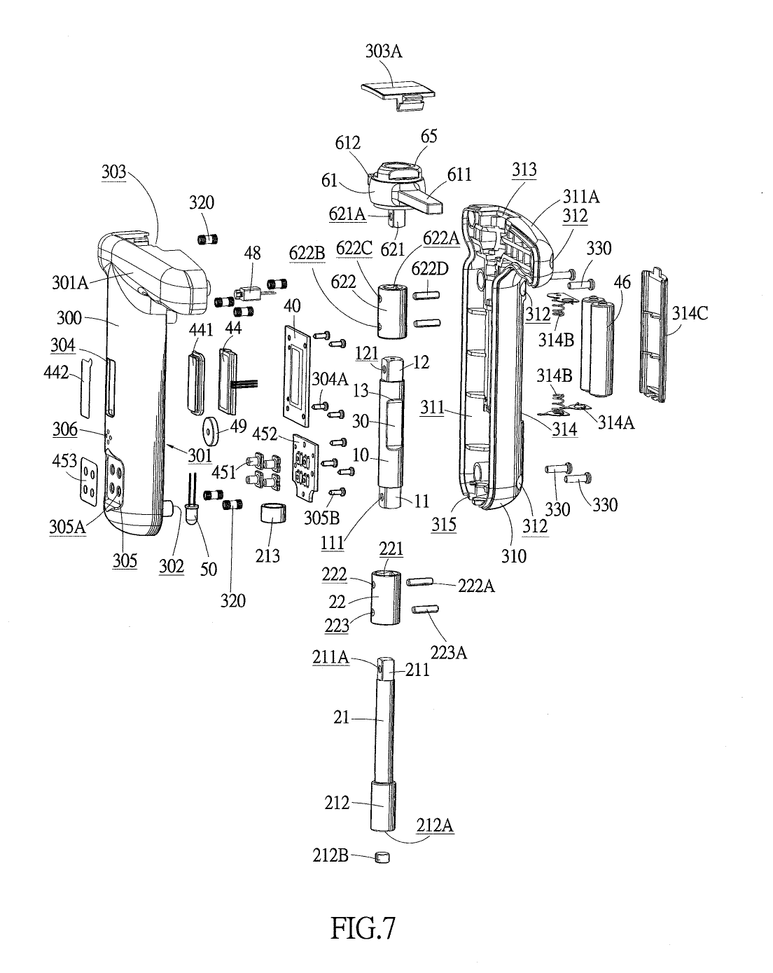

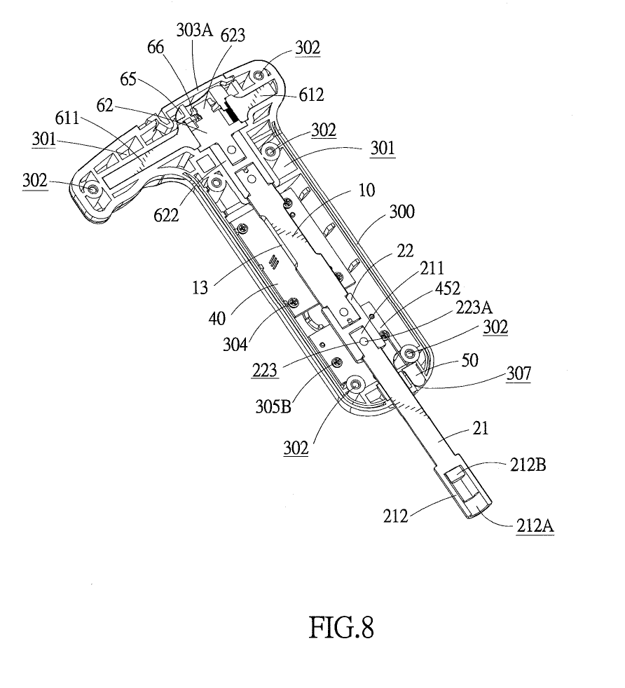

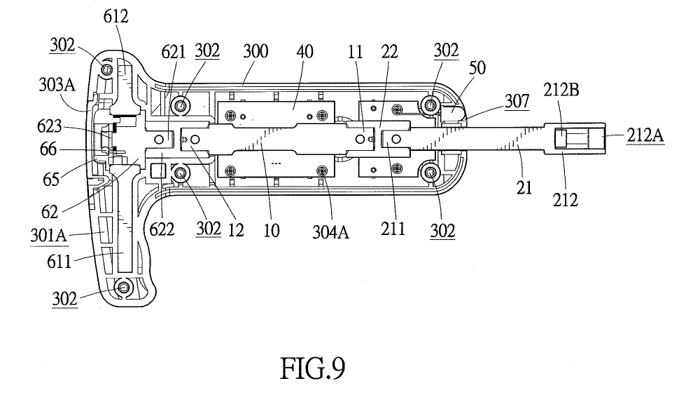

Referring to FIGS. 6-9, a preferred example of the application of the torque detection device 100 in accordance with the present invention is shown, wherein the connection body 10, the tool coupling bar 20, the torque detector 30, and the torque displaying/processing unit 40 of the torque detection device 100 of the present invention are mounted inside and coupled to a pair of hand tool housing members 300, 310. The hand tool housing members 300, 310 respectively form internal chambers 301, 311 for accommodating and retaining the connection body 10, the tool coupling bar 20, the torque detector 30, and the torque displaying/processing unit 40. The hand tool housing members 300, 310 respectively form a plurality of fixing holes 302, 312 for respectively receiving bolts 320, 330 to extend therethrough for securing.

An end of the extender 21 of the tool coupling bar 20 is fit through a collar 213 that serves as a bearing.

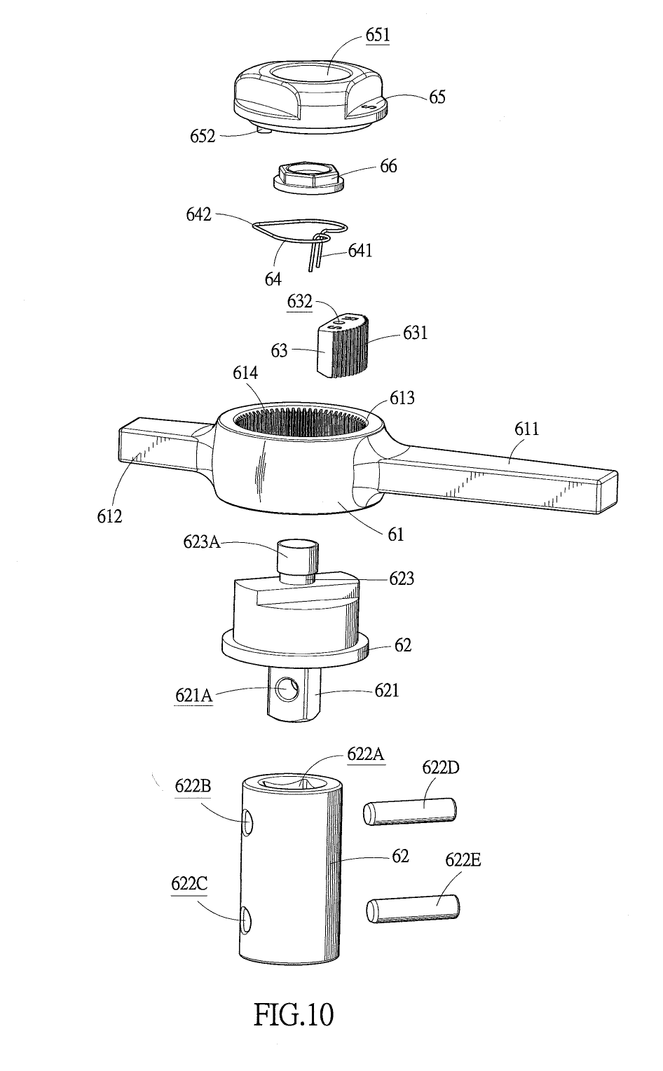

Referring also to FIG. 10, a direction-switching device 60 is received and fixed in handle portions 301A, 311A formed at rear ends of the hand tool housing members 300, 310 that form the chambers 301, 311. The handle portions 301A, 311A of the chambers 301, 311 form in rear ends thereof operation openings 303, 313 respectively. The operation openings 303, 313 are covered and closed by a lid 303A.

The direction-switching device 60 is not limited to any specific type and in the instant embodiment, a device composed of a support rack 61, a rotation joint 62, a direction controller 63, a heart-shaped spring 64, a direction switching knob 65, and a fastener nut 66 is taken as an example. The support rack 61 forms on an outside thereof at least two arms 611, 612 that function to fix in the rear end sections of the chambers 301, 311. The support rack 61 forms at least one bore 613 having an inside circumference forming teeth 614.

The rotation joint 62 has a lower end forming a body connection section 621 through which at least one connection hole 621A is defined and a coupler 622 forming at least one bore 622A that has two ends respectively receiving the insertion of the body connection section 621 and the connection end 12 of the connection body 10. The coupler 622 has an outer circumferential surface having opposite end portions respectively forming at least one securing hole 622B, 622C. The securing hole 622B corresponds to the connection hole 621A of the 612 to allow the extension of a pin 622D therethrough for connection so that the rotation joint 62 is coupled to an end of the coupler 622. The securing hole 622C of the coupler 622 corresponds to the connection hole 121 of the connection end 12 formed at one end of the connection body 10 to receive a pin 622E extending therethrough for connection, so that an end of the coupler 622 is connected to the connection end 12 formed at one end of the connection body 10. Thus, the rotation joint 62 and the connection body 10 are connected to each other, and are operated in unison with each other.

The rotation joint 62 has an upper end forming a connection axle 623 that has an outer circumference forming threading 623A. The connection axle 623 extends through the bore 613 of the support rack 61.

The direction controller 63 is received in the bore 613 of the support rack 61. The direction controller 63 has an outer surface forming teeth 631. The teeth 631 mate the teeth 614 of the bore 613. The direction controller 63 forms at least one central hole 632.

The heart-shaped spring 64 is fit to the connection axle 623 of the rotation joint 62 and has inner and outer ends respectively forming a pair of fitting legs 641 and a sharp tip 642. The fitting legs 641 are fit into the central hole 632 of the direction controller 63 to form a resilient coupling between the direction controller 63 and the heart-shaped spring 64.

The direction switching knob 65 forms a bore 651 at a center thereof. The bore 651 is fit over the connection axle 623 formed on the upper end of the rotation joint 62 and is fixed by the fastener nut 66 engaging the threading 623A formed on the outer circumference of the connection axle 623, whereby the direction switching knob 65 is rotatable about a center defined by the connection axle 623. The direction switching knob 65 has a lower end forming at least one a projection 652, which is received inside the sharp tip 642 of the heart-shaped spring 64 to couple with the heart-shaped spring 64, whereby the direction switching knob 65 may undergo clockwise rotation or counterclockwise rotation to drive the heart-shaped spring 64 for rotating the direction controller 63. In other words, the opposite side portions of the direction controller 63 are controlled by the clockwise or counterclockwise rotation of the direction switching knob 65 to establish clockwise or counterclockwise offset engagement with the teeth 614 of the bore 613 of the support rack 61 to function like a ratchet. When the rotation joint 62 is rotated by the rotation of the tool bit 200, if the engagement of the rotation joint 62 with the direction controller 63 is set in a forward engagement condition, then the connection body 10, the tool coupling bar 20, and the tool bit 200 are all allowed to take forward resilient torque rotation, but if the engagement of the rotation joint 62 with the direction controller 63 is set in a backward engagement condition, then the rotation of the tool bit 200 is prohibited, making the tool bit 200 only operable in single-direction ratchet-assisted resilient torque rotation. In other words, the connection body 10, the tool coupling bar 20, and the tool bit 200 can be set in single-direction clockwise or counterclockwise resilient torque rotation according to the switching selection made by the direction switching knob 65 for either clockwise rotation or counterclockwise rotation.

The hand tool housing member 300 forms in an outer wall thereof an LCD window 304 and a pushbutton window 305. The LCD window 304 uses a plurality of bolts 304A to secure the torque displaying/processing unit 40 and the display 44 thereto. The display 44 comprises a transparent protective lens 441 and a protection film 442 mounted to an outer surface thereof.

The pushbutton window 305 forms a plurality of pushbutton openings 305A. The pushbutton set 45 of the torque displaying/processing unit 40 comprises at least a plurality of pushbuttons 451, a pushbutton circuit board 452, and a pushbutton panel 453. The pushbuttons 451 are mounted on the pushbutton circuit board 452 and the pushbutton circuit board 452 is connected to the microprocessor 42 of the torque displaying/processing unit 40. The pushbutton circuit board 452 is secured to an inner side of the LCD window 304 through a plurality of bolts 305B to have the pushbuttons 451 projecting outward through the pushbutton openings 305A for manual operation. The pushbutton panel 453 is fit over the pushbuttons 451 and is attached to an outer side of the pushbutton window 305 and carries instructions regarding the operation functions of the pushbuttons 451.

The hand tool housing member 310 forms therein a power chamber 314 for accommodating a DC battery type power unit 46. The power chamber 314 receives therein a plurality of power contacts 314A, 314B for engaging the positive and negative electrodes of the power unit 46 respectively. The power contacts 314A, 314B are connected to the analog/digital conversion circuit 41, the microprocessor 42, the display interface 43, the display 44, the pushbutton set 45, the backlight panel 47, the vibration alarm element 48, the sound alarm element 49, and the secondary lighting device 50 for supplying working power thereto. The power chamber 314 comprises a cover 314C set on outside thereof for covering and closing the power chamber 314.

The hand tool housing members 300, 310 form in front ends thereof at least one lighting hole 307, 315 to fix the secondary lighting device 50 of the torque displaying/processing unit 40, whereby the secondary lighting device 50 may supply auxiliary lighting source for the rotation operation of the tool bit 200.

The sound alarm element 49 is set in the handle portions 301A, 311A on the rear ends of the chambers 301, 311 of the hand tool housing members 300, 310 to allow the sound alarm element 49 to transmit a vibration force to the handle portions 301A, 311A, whereby a user may be notified of the operation torque of the tool bit 200 exceeding a threshold through the vibration of the handle portions 301A, 311A.

The hand tool housing member 300 forms in an outer wall thereof a plurality of sound apertures 306. The sound alarm element 49 is set on an inner side of the sound apertures 306 of the hand tool housing member 300, whereby the sound apertures 306 may transmit and give off sound alarm to notify a user of the operation torque of the tool bit 200 exceeding a threshold through the alarm sound so given off.

The coupling between the connection body 10, the tool coupling bar 20, the torque detector 30, and the torque displaying/processing unit 40 of the torque detection device 100 and the hand tool housing members 300, 310 is not limited to what shown in FIGS. 6-9. For example, the connection end 12 that is formed on one end of the connection body 10 does not need to be coupled to the direction-switching device 60, and instead, can be directly coupled to the inside of the chambers 301, 311 of the hand tool housing members 300, 310 or the handle portions 301A, 311A of the chambers 301, 311. Modification of this type is considered within the scope of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A torque detection and display device comprising:
at least one connection body having opposite ends respectively forming connection ends and an outer circumference forming at least one retention section;
at least one tool coupling bar having an end connected to one connection end of the connection body and an opposite end adapted to connect to a tool bit, which carries out a rotation operation on a fastener element;
at least one torque detector, which is mounted to the retention section of the connection body to detect a torque value occurring in the rotation operation of the tool bit that is connected to one end of the tool coupling bar; and
at least one torque displaying/processing unit, which is composed of circuitry that displays a torque value and displays operation functions, the torque displaying/processing unit being connected to the torque detector to receive the torque detection signal generated by the torque detector for displaying an actual torque value of the rotation operation of the tool bit connected to one end of the tool coupling bar.

2. The torque detection and display device as claimed in claim 1, wherein the connection end formed on one end of the connection body is connected to a direction-switching device.

3. The torque detection and display device as claimed in claim 2, wherein the direction-switching device comprises:
a support rack, which forms at least one bore having an inside circumference forming teeth;
a rotation joint, which has a lower end forming a body connection section for connection with the connection end formed on one end of the connection body to have the rotation joint and the connection body connected to each other and in driving coupling with each other, and an upper end forming a connection axle that extends through the bore of the support rack;
a direction controller, which is received in the bore of the support rack and has an outer surface forming teeth that mate the teeth of the bore, the direction controller forming at least one central hole;
a heart-shaped spring, which is fit to the connection axle of the rotation joint and has inner and outer ends respectively forming fitting legs and a sharp tip, the fitting legs being fit into the central hole of the direction controller to form a resilient coupling between the direction controller and the heart-shaped spring; and
a direction switching knob and a fastener nut, the direction switching knob forming a bore at a center thereof for being fit over the connection axle formed on the upper end of the rotation joint and fixed by the fastener nut to the outer circumference of the connection axle, the direction switching knob being rotatable about a center defined by the connection axle, the direction switching knob having a lower end forming at least one a projection, which is received inside the sharp tip of the heart-shaped spring to couple with the heart-shaped spring, whereby the direction switching knob undergoes clockwise rotation or counterclockwise rotation, the heart-shaped spring is driven to rotate the direction controller, so that the connection body is selectively set in single-direction clockwise or counterclockwise resilient torque rotation by switching selection made by the direction switching knob for clockwise rotation or counterclockwise rotation.

4. The torque detection and display device as claimed in claim 3, wherein the body connection section of the rotation joint is connected to the connection end of the connection body through a coupler.

5. The torque detection and display device as claimed in claim 1, wherein each of the opposite ends of the connection body forms a connection hole.

6. The torque detection and display device as claimed in claim 1, wherein the tool coupling bar comprises:
an extender, which has opposite ends respectively forming a body connection section and a tool connection section, the tool connection section having an end forming at least one connection bore for receiving insertion of an end of the tool bit; and
an adaptor, which forms therein at least one connection hole that has two ends respective for receiving insertion of the connection end of the connection body and the body connection section 1 formed on an end of the extender.

7. The torque detection and display device as claimed in claim 1, wherein the connection bore of the extender receives therein at least one magnet.

8. The torque detection and display device as claimed in claim 1, wherein the torque detector comprises a sensor element that employs strain/deformation detection of torque value.

9. The torque detection and display device as claimed in claim 1, wherein the torque detector comprises a sensor element that employs semiconductor detection of torque value.

10. The torque detection and display device as claimed in claim 1, wherein the torque displaying/processing unit comprises:
at least one torque displaying/processing unit, which is connected to the torque detector to convert the torque detection signal into a digital torque value;
at least one microprocessor, which is connected to the analog/digital conversion circuit to receive an output of torque value from the analog/digital conversion circuit, the microprocessor providing functions of temporary data storage, display control, and manipulation;
at least one display interface, which is connected to the microprocessor to convert the torque value into a torque displaying signal;
at least one display, which is connected to the display interface to process and display the torque displaying signal from the display interface;
at least one pushbutton set, which is connected to the microprocessor to provide instructions for displaying operation to the microprocessor; and
at least one power unit, which supplies working power to the analog/digital conversion circuit, the microprocessor, the display interface, the display, and the pushbutton set.

11. The torque detection and display device as claimed in claim 1, wherein the torque displaying/processing unit comprises:
at least one torque displaying/processing unit, which is connected to the torque detector to convert the torque detection signal into a digital torque value;
at least one microprocessor, which is connected to the analog/digital conversion circuit to receive an output of torque value from the analog/digital conversion circuit, the microprocessor providing functions of temporary data storage, display control, manipulation, setting a threshold and alarm of exceeding of the threshold, on/off operation of secondary lighting;
at least one display interface, which is connected to the microprocessor to convert the torque value into a torque displaying signal;
at least one display, which is connected to the display interface to process and display the torque displaying signal from the display interface;
at least one pushbutton set, which is connected to the microprocessor to provide instructions for displaying operation to the microprocessor;
at least one power unit, which supplies working power to the analog/digital conversion circuit, the microprocessor, the display interface, the display, and the pushbutton set;
a backlight panel, which is connected to the microprocessor to provide backlighting for displaying by the display;
at least one vibration alarm element and one sound alarm element, which are connected to the microprocessor, whereby the microprocessor, upon detecting a torque value exceeding a threshold, activates the vibration alarm element and the sound alarm element to generate a vibration force and a sound alarm; and
at least one secondary lighting device, which is connected to the microprocessor and the power unit, the secondary lighting device being controlled by the microprocessor to light on or off in accordance with control instructions of light on/off entered through the pushbutton set to the microprocessor.

12. The torque detection and display device as claimed in claim 10 or 11, wherein the display comprises a liquid crystal display.

13. The torque detection and display device as claimed in claim 10 or 11, wherein the power unit comprises a direct-current battery.

14. The torque detection and display device as claimed in claim 10 or 11, wherein the power unit comprises a direct-current rectification device.

15. The torque detection and display device as claimed in claim 11, wherein the vibration alarm element comprises a vibration motor.

16. The torque detection and display device as claimed in claim 11, wherein the sound alarm element comprises a buzzer.

17. The torque detection and display device as claimed in claim 11, wherein the secondary lighting device comprises high-brightness light-emitting diodes.

18. The torque detection and display device as claimed in claim 1, wherein the connection body, the tool coupling bar, the torque detector, and the torque displaying/processing unit are coupled to and enclosed by a pair of hand tool housing members.
